(19) United States
(12) Patent Application Publication
(10) Pub. No.: US 2009/0206591 A1
(43) Pub. Date: Aug. 20, 2009

(54) Book and Method for Manufacture Thereof

(75) Inventor: Hugo Cornelis Van Woerden, Akkrum (NL)

Correspondence Address: THE WEBB LAW FIRM, P.C., 700 KOPPERS BUILDING, 436 SEVENTH AVENUE, PITTSBURGH, PA, 15219, US

(73) Assignee: Jongbloed B.V., Heerenveen (NL)

(21) Appl. No.: 12/305,573

(22) PCT Filed: Jun. 28, 2007
(86) PCT No.: PCT/NL2007/000163

§ 371 Date: Feb. 13, 2009

(30) Foreign Application Priority Data
Jun. 28, 2006 (NL) 1032073

(51) Int. Cl. B42D 1/00

(52) U.S. Cl. 281/38; 412/1

(57) ABSTRACT

A book comprising a plurality of sheets, which sheets are mutually-connected on a spine side and which are provided at least substantially with text on both pages within predetermined margins, which text consists of lines with words which can be read by a reader in a reading direction, wherein at least almost all lines on at least almost all pages of the book extend parallel to the spine of the book, and that the lines on two adjoining pages of two adjoining sheets are arranged in the same reading direction in the opened position of the book such that the reader can read the text on both adjoining pages in the same reading direction without rotating the book.

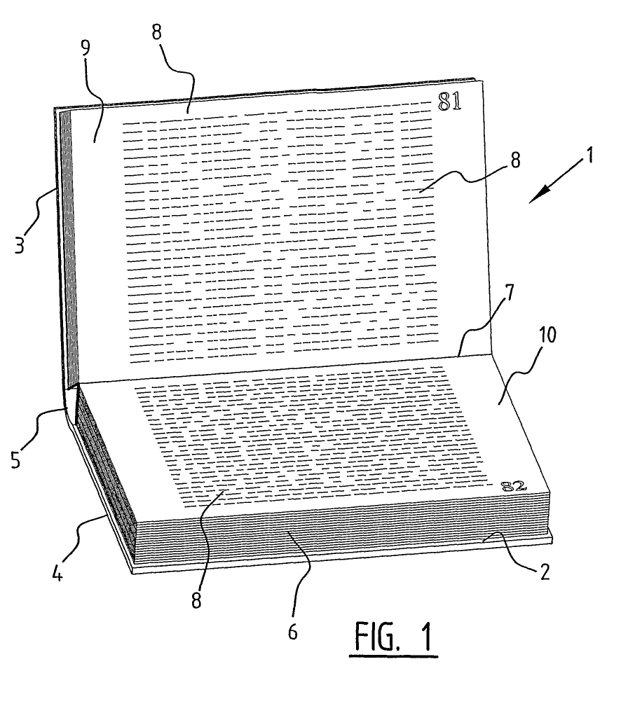

The invention relates to a book comprising a plurality of sheets, which sheets are mutually connected on a spine side and which are provided at least substantially with text on both pages within predetermined margins, which text consists of lines with words which can be read by a reader in a reading direction.

Such books are generally known. Books are often read in reclining position, for instance in bed or, in fine weather, outside in the sun on a mattress or on the beach. A problem which occurs here is that, while the reader can, when reading a page, rest the spine of the book on the surface (for instance the mattress) on which the reader is lying, the spine of the book has to be lifted up in order to read the facing page, or the reader must turn over onto his/her other side. Another way of reading a book when lying down is on the back with the book in both hands above the head. This is very tiring for the reader and results in irritation. The invention has for its object to resolve these problems.

NL-C-1022866 proposes to print two facing pages at a time with the same text so that the reader can choose which page he/she reads. The amount of text to be printed is however hereby doubled.

According to the invention at least almost all lines on at least almost all pages of the book extend parallel to the spine of the book, and the lines on two adjoining pages of two adjoining sheets are arranged in the same reading direction in the opened position of the book such that the reader can read the text on both adjoining pages in the same reading direction without rotating the book. In the opened position of the book the text is therefore visible as a continuous text on the two facing pages, wherein the seam of the spine extends parallel to the lines in the middle and wherein half of the lines are situated above this seam and the other half of the text is situated below this seam. In this way the reader can hold the book to the side of the lines, for instance with a hand which is resting on the mattress, and thus read the book. The book can herein be held both on the left-hand side and the right-hand side of the lines. He/she can thus choose him/herself the side on which to lie, and does not have to lift up the book.

The lines on the two pages of one sheet are preferably arranged in the same reading direction such that the reader can read the text on both pages in the same reading direction after turning the page without rotating the book. If the sheet were held against the light with the lines on the side directed toward the reader in the normal reading direction, the lines on the side remote from the reader could therefore then be read upside down but in the same reading direction if the sheet is thin enough.

In the opened position the book preferably has a size smaller than 15 cm by 10 cm, preferably smaller than 12 cm by 8 cm. Such a size can be held easily and for a long time in the opened position with one hand. The margins on both sides of at least almost all lines in the book amount preferably to at least 1.0 cm, more preferably at least 1.5 cm. In this way the reader can clamp the book on the side with one hand in the opened position, wherein the thumb of this hand can partially cover the margin both above and below the seam of the spine, and clamp the cover side of the book against the fingers of this hand.

The thickness of the sheets is preferably less than 0.1 mm, more preferably less than 0.06 mm, even more preferably less than 0.04 mm, and the book preferably comprises at least 30 sheets. At least most pages preferably also comprise at least 500 characters, more preferably at least 1,000 characters, even more preferably at least 1,500 characters. In this way the book, which preferably has a small size, can still have sufficient text to accommodate for instance a complete novel. Such a size of book is particularly suitable to take along when travelling.

As in many traditional books, two sheets are preferably formed in each case by a leaf that is folded double, the sheets are manufactured from paper, the sheets are bound or glued on the spine side, and the book is provided with a cover manufactured from a thicker and more rigid material than the sheets, such as cardboard.

The invention also relates to a method for manufacturing a book, wherein a plurality of sheets are mutually connected on a spine side, wherein at least substantially text is arranged on both pages within predetermined margins, which text consists of lines with words which can be read by a reader in a reading direction, wherein at least almost all lines on at least almost all pages of the book extend parallel to the spine of the book, and wherein the lines on two adjoining pages of two adjoining sheets are arranged in the same reading direction in the opened position of the book such that the reader can read the text on both adjoining pages in the same reading direction without rotating the book.

The invention will be further elucidated on the basis of an exemplary embodiment shown in the FIGURE.

Book 1 comprises a cardboard cover 2 with front side 3, a rear side 4 and a spine 5. Sheets 6 are bound in traditional manner, for instance in quires, and attached to cover 2. The book is opened in the FIGURE at pages ‘81’ and ‘82’ and a seam 7 is visible which runs parallel to spine 5.

The dimensions of the book in the closed position are for instance 11 cm by 7.5 cm. The book comprises for instance 200 paper sheets 0.05 mm thick, and thus has 400 pages. The text printed in the book consists of for instance 600,000 characters.

The text in book 1 comprises lines 8 printed parallel to seam 7. In the shown opened position the lines on page ‘81’ and on page ‘82’ are printed in the same reading direction. A reader can thus read the text on both page ‘81’ and ‘82’ without turning the book. When the reader reaches the end of page ‘82’, he/she turns this page and comes to page ‘83’ and ‘84’ where the lines are oriented in the same manner. The reader can thus continue to read without turning the book 1. All pages of book 1 are printed in the same manner.

Margins 9, 10 at least 1.0 cm wide are provided on the pages on the left-hand side and on the right-hand side of the text. The reader can here grip book 1 with the straightened thumb of one hand and grip the rear side of cover 2 of book 1 with the remaining fingers, and thus hold book 1 in the opened position with one hand. This can be done with the left or right hand as desired, while the reader is for instance lying on a bed.

1-12. (canceled)

13. A book comprising a plurality of sheets, which sheets are mutually connected on a spine side and which are provided at least substantially with text on both pages within predetermined margins, which text consists of lines with words which can be read by a reader in a reading direction, wherein at least almost all lines on at least almost all pages of the book extend parallel to the spine of the book, and wherein the lines on two adjoining pages of two adjoining sheets are arranged in the same reading direction in the opened position of the book such that the reader can read the text on both adjoining pages in the same reading direction without rotating the book.

14. The book as claimed in claim 13, wherein the lines on the two pages of one sheet are arranged in the same reading direction such that the reader can read the text on both pages in the same reading direction after turning the page without rotating the book.

15. The book as claimed in claim 13, wherein in the opened position the book has a size smaller than 15 cm by 10 cm, preferably smaller than 12 cm by 8 cm.

16. The book as claimed in claim 13, wherein the margins on both sides of at least almost all lines in the book amount to at least 1.0 cm, preferably 1.5 cm.

17. The book as claimed in claim 13, wherein the thickness of the sheets is less than 0.1 mm, preferably less than 0.06 mm, more preferably less than 0.04 mm.

18. The book as claimed in claim 13, wherein the book comprises at least 30 sheets.

19. The book as claimed in claim 13, wherein at least most pages comprise at least 500 characters, preferably at least 1,000 characters, more preferably at least 1,500 characters.

20. The book as claimed in claim 13, wherein two sheets are formed in each case by a leaf that is folded double.

21. The book as claimed in claim 13, wherein the sheets are manufactured from paper.

22. The book as claimed in claim 13, wherein the sheets are bound or glued on the spine side.

23. The book as claimed in claim 13, wherein the book is provided with a cover manufactured from a thicker and more rigid material than the sheets.

24. A method for manufacturing a book, wherein a plurality of sheets are mutually connected on a spine side, and wherein at least substantial text is arranged on both pages within predetermined margins, which text consists of lines with words which can be read by a reader in a reading direction, wherein at least almost all lines on at least almost all pages of the book extend parallel to the spine of the book, and wherein the lines on two adjoining pages of two adjoining sheets are arranged in the same reading direction in the opened position of the book such that the reader can read the text on both adjoining pages in the same reading direction without rotating the book.
